(19) United States
(12) Patent Application Publication
(10) Pub. No.: US 2015/0091404 A1
(43) Pub. Date: Apr. 2, 2015

(54) ROTOR FOR ROTATING ELECTRIC MACHINE, ROTATING ELECTRIC MACHINE, AND MAGNETIZING APPARATUS FOR ROTATING ELECTRIC MACHINE

(71) Applicant: KABUSHIKI KAISHA YASKAWA DENKI, Kitakyushu-shi (JP)

(72) Inventor: Kenji FUNAKOSHI, Kitakyushu-shi (JP)

(73) Assignee: KABUSHIKI KAISHA YASKAWA DENKI, Kitakyushu-shi (JP)

(21) Appl. No.: 14/499,247

(22) Filed: Sep. 29, 2014

(30) Foreign Application Priority Data
Oct. 2, 2013 (JP) 2013-207301

(51) Int. Cl. H02K 1/27; H02K 15/03; H02K 1/28; H01F 13/00

(52) U.S. Cl. CPC H02K 1/278; H01F 13/003; H02K 15/03; H02K 1/28
USPC 310/156.21; 335/284

(57) ABSTRACT

A rotor for a rotating electric machine includes a rotor core including a plurality of laminated steel plates; a permanent magnet fixed to an outer peripheral surface of the rotor core, the permanent magnet having a length in an axial direction less than that of the rotor core; and an adhesive member disposed on a region of the outer peripheral surface of the rotor core between an end of the permanent magnet in the axial direction and an end of the rotor core in the axial direction.

### CROSS-REFERENCE TO RELATED APPLICATIONS

The present application claims priority under 35 U.S.C. §119 to Japanese Patent Application No. 2013-207301, filed Oct. 2, 2013. The contents of this application are incorporated herein by reference in their entirety.

### BACKGROUND

1. Field of the Invention

The embodiments disclosed herein relate to a rotating electric machine.

2. Description of the Related Art

Japanese Unexamined Patent Application Publication No. 10-336976 discloses a magnetizing apparatus for magnetizing a rotor for a rotating electric machine, the rotor having permanent magnets as magnetic poles. The magnetizing apparatus includes a rotation shaft and a magnetizing yoke. The rotation shaft holds a rotor, on which magnet members to be magnetized are mounted, and rotates so as to magnetize the magnet members. The magnetizing yoke includes a core and a coil wound around the core. When a direct electric current is passed through the coil, the magnetizing yoke generates magnetic flux and magnetizes magnetic poles of the rotor.

In the magnetizing apparatus described above, the magnetic members, each having a length less than that of the rotor in the axial direction, are fixed to a surface of the rotor. The magnetizing yoke has a length greater than that of the rotor in the axial direction. Therefore, the following problem may occur. In a region in which the magnetizing yoke faces the magnet members and the rotor, magnetic flux generated by the magnetizing yoke passes through the magnet members and the rotor. However, in a region in which the magnetizing yoke protrudes from an end portion of the rotor, magnetic flux generated by the magnetizing yoke is concentrated on the outer peripheral side of the end portion of the rotor. As a result, in a case where a core of the rotor is made by laminating steel plates, a magnetic attraction force directed outward in the axial direction is applied to the outer peripheral side of a steel plate at the end portion of the core of the rotor, and therefore the steel plate might be deformed in such a way that the steel plate is warped outward in the axial direction.

### SUMMARY

According to an aspect of the present disclosure, there is provided a rotor for a rotating electric machine, the rotor including a rotor core including a plurality of laminated steel plates; a permanent magnet fixed to an outer peripheral surface of the rotor core, the permanent magnet having a length in an axial direction less than that of the rotor core; and an adhesive member disposed on a region of the outer peripheral surface of the rotor core between an end of the permanent magnet in the axial direction and an end of the rotor core in the axial direction.

According to another aspect of the present disclosure, there is provided a rotor for a rotating electric machine, the rotor including a rotor core including a plurality of laminated steel plates; a permanent magnet fixed to an outer peripheral surface of the rotor core, the permanent magnet having a length in an axial direction less than that of the rotor core; and means for bonding the plurality of steel plates in a lamination direction, the means being disposed on a region of the outer peripheral surface of the rotor core between an end of the permanent magnet in the axial direction and an end of the rotor core in the axial direction.

According to another aspect of the present disclosure, there is provided a rotating electric machine including a stator, the rotor, and a shaft to which the rotor is fixed.

According to another aspect of the present disclosure, there is provided a magnetizing apparatus for magnetizing the rotor for a rotating electric machine, the magnetizing apparatus including a magnetizing yoke having a length in the axial direction greater than that of the rotor core.

### BRIEF DESCRIPTION OF THE DRAWINGS

FIG. 1 is an axial sectional view of a rotating electric machine according to an embodiment.

FIG. 2 is a cross-sectional view of the rotating electric machine.

FIG. 3 is a cross-sectional view an outer peripheral portion of a rotor of the rotating electric machine.

FIG. 4 is an external side view of the rotor.

FIG. 5 is a cross-sectional view illustrating an example of the structure of a magnetizing apparatus.

FIG. 6 illustrates the behavior of magnetic flux relative to a rotor core when the magnetizing apparatus magnetizes a magnet member.

FIG. 7 is a cross-sectional view of a rotor including an annular permanent magnet.

### DESCRIPTION OF THE EMBODIMENTS

Hereinafter, an embodiment will be described with reference to the drawings.

### Overall Structure of Rotating Electric Machine

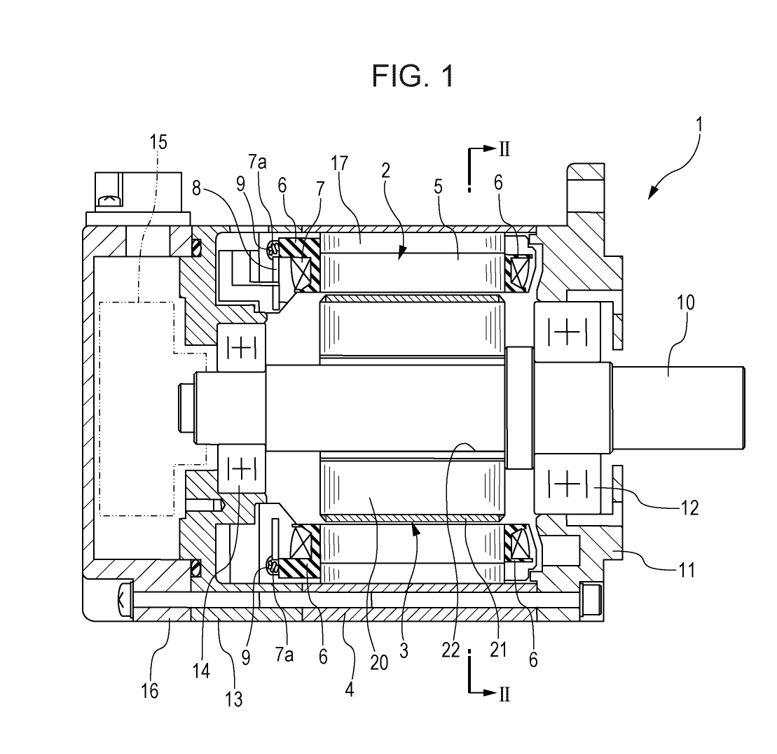

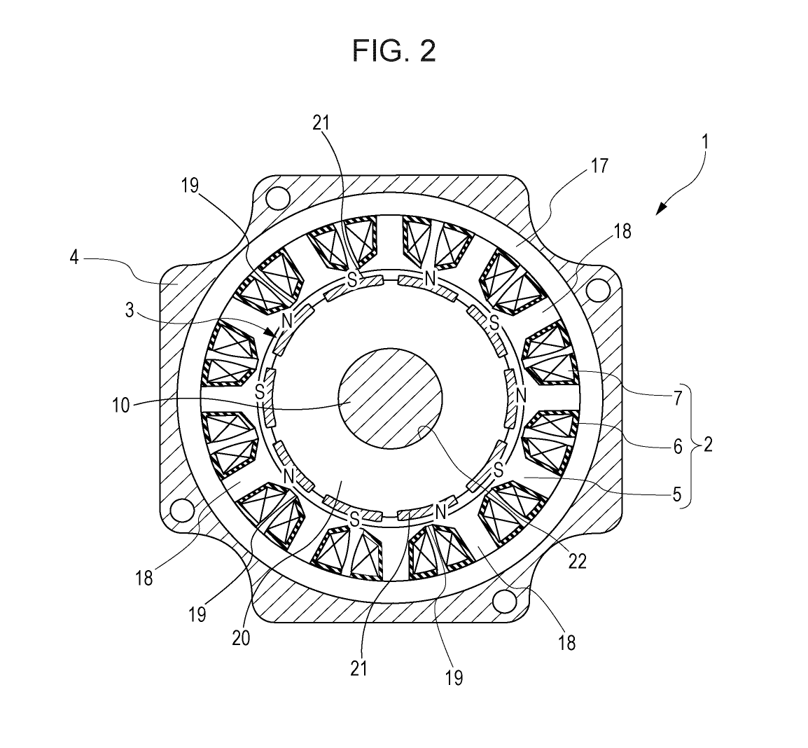

First, referring to FIGS. 1 and 2, the structure of a rotating electric machine 1 according to the embodiment will be described.

As illustrated in FIGS. 1 and 2, the rotating electric machine 1 includes a stator 2 and a rotor 3. The rotating electric machine 1 is an inner rotor motor, in which the rotor 3 is disposed inside of the stator 2. In this example, the rotating electric machine 1 has a slot combination of 10-pole/12-slot, in which the stator 2 has twelve teeth 18 (and twelve slots 19) and the rotor 3 has ten permanent magnets.

The stator 2 is attached to an inner peripheral surface of a frame 4 via a laminated core ring 17 so as to face the rotor 3 in the radial direction with a magnetic gap therebetween. The stator 2 includes a stator core 5, bobbins 6 attached to the stator core 5, and coil wires 7 wound around the bobbins 6. The bobbins 6 are made of an insulating material so that the stator core 5 can be electrically insulated from the coil wires 7. A circuit board 8 is disposed on one side of each bobbin 6 in the axial direction (the left side in FIG. 1). A circuit formed in the circuit board 8 is electrically connected to a corresponding one of the coil wires 7, which is wound around the bobbin 6, through two pin terminals 9, which are square-bar-shaped. End portions 7a of each coil wire 7 at the winding start portion and the winding end portion are wound around the pin terminals 9 and fixed to the pin terminals 9 with solder or the like (not shown).

The rotor 3 is attached to an outer peripheral surface of a shaft 10. The shaft 10 is rotatably supported by a loaded-side bearing 12 and an unloaded-side bearing 14. The outer race of the loaded-side bearing 12 is fitted into a loaded-side bracket 11 disposed on the loaded-side of the frame 4 (the right side in FIG. 1). The outer race of the unloaded-side bearing 14 is fitted into an unloaded-side bracket 13 disposed on the unloaded-side of the frame 4 (the left side in FIG. 1). An encoder 15 is disposed at an end of the shaft 10 on the unloaded side. The encoder 15 is covered by an encoder cover 16. The rotor 3 includes a rotor core 20 and a plurality of permanent magnets 21 disposed on the rotor core 20.

The stator core 5 is a cylindrical core formed by laminating a plurality of steel plates. As illustrated in FIG. 2, the stator core 5 has the plurality of (in this example, twelve) teeth 18 protruding outward in the radial direction. The bobbins 6, around which the coil wires 7 are wound, are attached to the teeth 18 from the outer sides of the teeth 18. The slots 19 are formed between each pair of adjacent teeth 18. Side portions of the coil wires 7 wound around the bobbins 6 of adjacent teeth 18 are disposed in the slots 19 so as to face each other with spaces therebetween. The stator 2 is assembled by attaching the bobbins 6, around which the coil wires 7 are wound, to the stator core 5, and by fixing the stator core 5 to the inner periphery of the laminated core ring 17. Then, the stator 2 is attached to the inner peripheral surface of the frame 4. Subsequently, a resin is injected into the slots 19, and the resin is molded so as to surround the bobbins 6, the coil wires 7, and the like.

### Structure of Rotor

The rotor core 20 is a cylindrical core formed by laminating a plurality of steel plates. As illustrated in FIG. 2, the plurality of (in this example, ten) permanent magnets 21 are disposed on the outer peripheral surface of the rotor core 20. The rotor core 20 has a center hole 22, into which the shaft 10 is fitted. The shaft 10 extends through the center hole 22 and protrudes outward from both end portions of the rotor core 20. The permanent magnets 21 are disposed at positions that are located outward from the center hole 22 in the radial direction. The permanent magnets 21 are arranged along the outer peripheral surface of the rotor core 20 with a predetermined distance therebetween. The permanent magnets 21, each having an N pole or an S pole, are disposed on the outer peripheral surface of the rotor core 20 in such a way that N poles and S poles are alternately arranged in the circumferential direction.

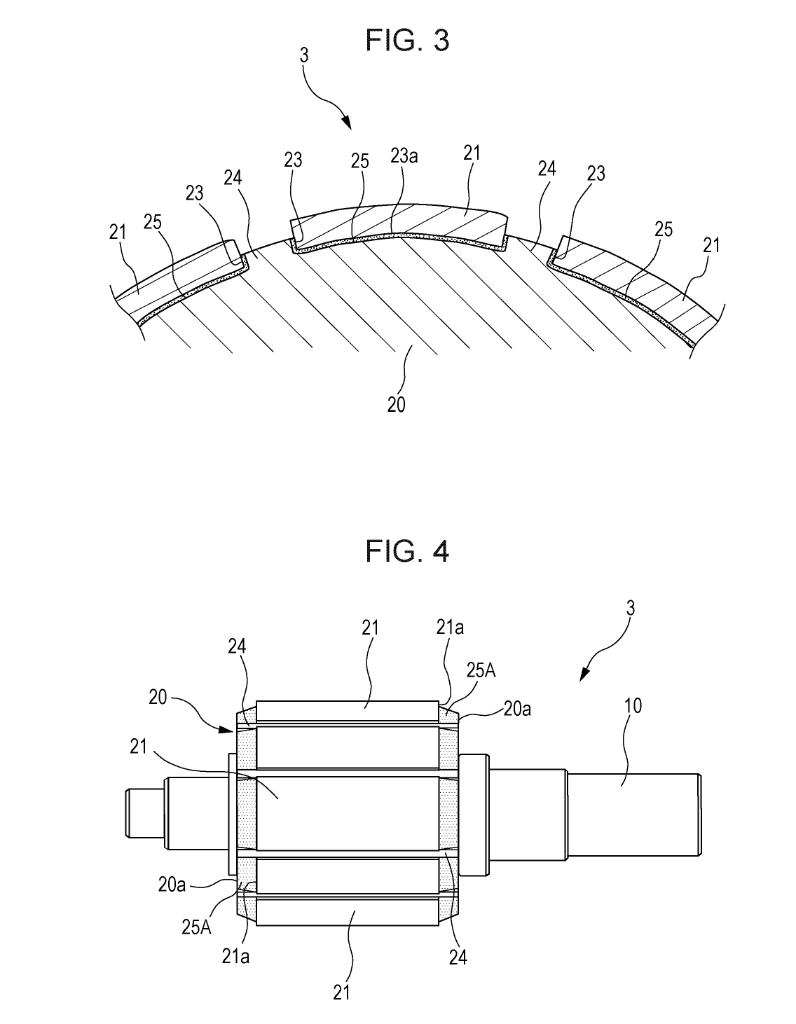

As illustrated in FIG. 3, in a cross-sectional view, each of the permanent magnets 21 is shaped like a substantially arc-shaped plate (or a substantially rectangular plate) extending along the circumference of the rotor core 20. As illustrated in FIG. 4, the length of each of the permanent magnets 21 in the axial direction is less than that of the rotor core 20. A plurality of bonding grooves 23, to which the permanent magnets 21 are bonded, and protrusions 24, which are located between the bonding grooves 23, are alternately arranged on the outer peripheral surface of the rotor core 20 in the circumferential direction. Each of the bonding grooves 23 and the protrusions 24 has a length in the axial direction corresponding to the length of the rotor core 20 between both end portions of the rotor core 20. Each of the bonding grooves 23 has a bottom portion 23a having a shape corresponding the cross-sectional shape of the permanent magnet 21 (or a flat shape). In this example, each of the bonding grooves 23 has such a depth that substantially a half of the permanent magnet 21 in the radial direction is disposed inside the bonding groove 23.

The permanent magnets 21 are fixed in place by adhesive members 25, which are formed from an adhesive applied to the bonding grooves 23. The permanent magnets 21 are arranged on the outer peripheral surface of the rotor core 20 in the circumferential direction with the protrusions 24 therebetween so as to be separated from each other by a predetermined distance. As illustrated in FIG. 4, adhesive members 25A are disposed on regions of the outer peripheral surface of the rotor core 20 at both ends in the axial direction, the regions being located between end portions 21a of each of the permanent magnets 21 in the axial direction and end portions 20a of the rotor core 20 in the axial direction. The adhesive members 25A (examples of a leaked-out portion) are formed from an adhesive that has been applied the bonding grooves 23 and has leaked out from the end portions 21a outward in the axial direction due to bonding of the permanent magnets 21 to the bonding grooves 23. The adhesive members 25A are arranged so as to cover the outer peripheral surface of the rotor core 20. The amount of adhesive applied to the bonding grooves 23 is adjusted to be slightly more than necessary so that the adhesive members 25A can be formed. The function of the adhesive members 25A will be described below.

### Structure of Magnetizing Apparatus

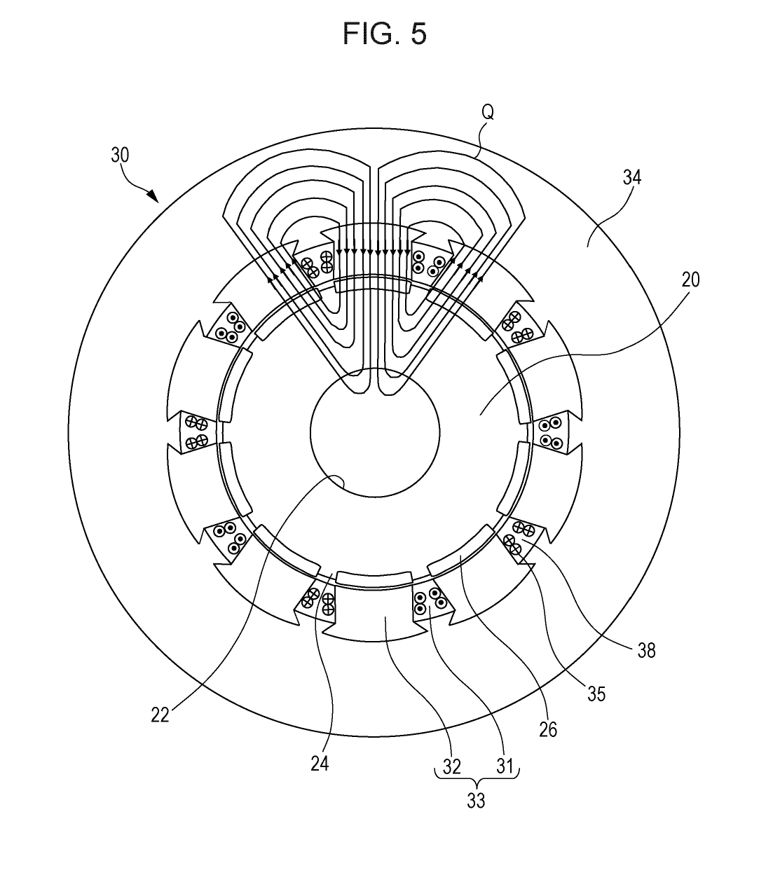

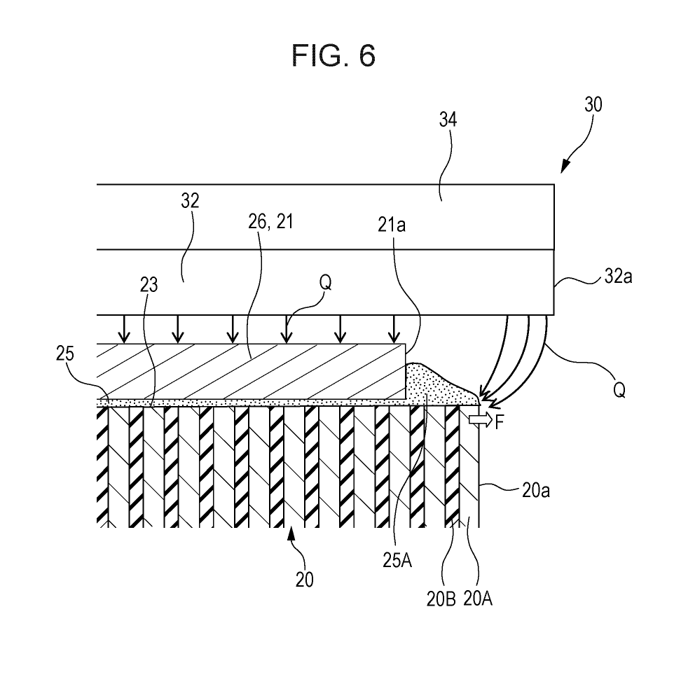

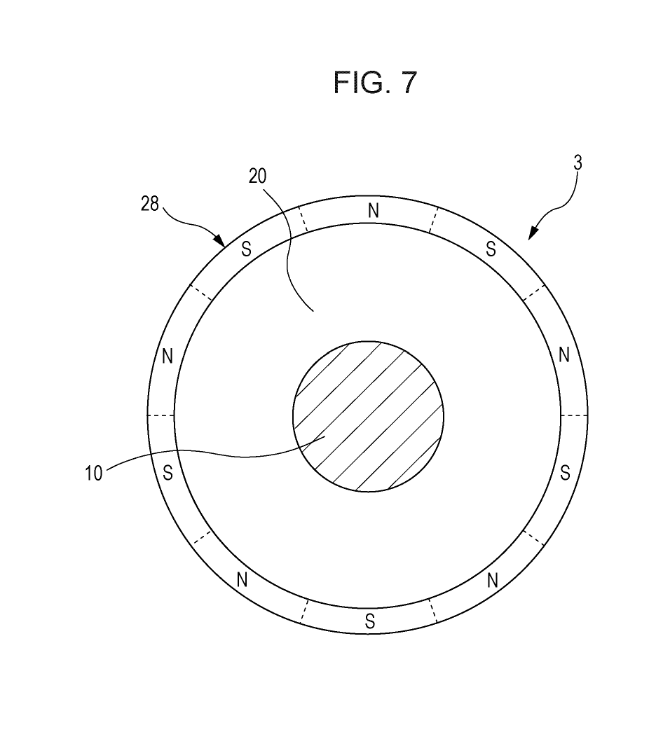

In the present embodiment, the permanent magnets 21 of the rotor core 20 are formed by magnetizing unmagnetized magnet member 26 (see FIGS. 5 and 6), which are affixed to the rotor core 20, by using a magnetizing apparatus. FIG. 5 is a cross-sectional view illustrating an example of the structure of a magnetizing apparatus.

As illustrated in FIG. 5, a magnetizing apparatus 30 includes a cylindrical magnetizing yoke 34, a plurality of (in this example, ten) teeth 32, a plurality of (in this example, ten) slots 31, yoke coils 35, and sealing members 38. The teeth 32 are arranged inside of the magnetizing yoke 34 at a regular pitch in the circumferential direction. The slots 31 are disposed inside of the magnetizing yoke 34 between adjacent teeth 32. The yoke coils 35, for generating magnetic fields, are wound in the slots 31. Spaces between the yoke coils 35 are filled with the sealing members 38. Each of the slots 31 and a corresponding one of the teeth 32 constitute a magnetic pole 33. The magnetizing yoke 34 and the teeth 32 have the same length in the axial direction (a direction perpendicular to the plane of FIG. 5).

Before the shaft 10 is (or after the shaft has been) inserted into the center hole 22, the rotor core 20 is inserted into the magnetizing yoke 34 of the magnetizing apparatus 30 in such a way that the unmagnetized magnet members 26, which are fixed to the outer peripheral surface of the rotor core 20, face the teeth 32. When the yoke coils 35 are energized, the yoke coils 35 generate magnetic fluxes Q that pass through the teeth 32, and therefore each of the magnet members 26 is magnetized so as to have a desired polarity.

In general, the length of the rotor core 20 in the axial direction differs according to the type and the size of the rotating electric machine 1. If it were necessary to use magnetizing apparatuses of different types, which include magnetizing yokes having different lengths in the axial direction, in order to magnetize the rotating electric machines 1 of different types, maintenance of the magnetizing apparatuses would become difficult and the cost would considerably increase. Therefore, according to the present embodiment, the magnetizing yoke 34 of the magnetizing apparatus 30 has a comparatively large length in the axial direction. (For example, the magnetizing yoke 34 may have a length in the axial direction that is the same as the largest length of the rotor cores 20 of the rotating electric machines 1 to be magnetized.) Accordingly, the magnetizing yoke 34 (including the teeth 32) is designed so that a single magnetizing apparatus including the magnetizing yoke 34 can be generally used to magnetize permanent magnets of various rotating electric machines 1 having different lengths in the axial direction.

### Function of Adhesive Member

In the present embodiment, as described above, the adhesive members 25A are disposed on regions of the outer peripheral surface of the rotor core 20 between the end portions 21a of each of the permanent magnets 21 in the axial direction and the end portions 20a of the rotor core 20 in the axial direction. The function of the adhesive members 25A will be described below.

FIG. 6 illustrates the behavior of magnetic flux relative to the rotor core 20 when the magnetizing apparatus 30 magnetizes one of the magnet members 26. As described above, the magnetizing apparatus 30 is designed so that it can be generally used for various rotating electric machines 1. Therefore, as illustrated in FIG. 6, when the rotor core 20 that is inserted into the magnetizing yoke 34 has a length in the axial direction less than that of the cylindrical magnetizing yoke 34 (each of the teeth 32), the end portion 20a of the rotor core 20 is located at a position separated from an end portion 32a, in the axial direction, of each of the teeth 32 toward the inside of the magnetizing yoke 34 (the left side in FIG. 6).

Therefore, in a region in which each of the teeth 32 faces the magnet member 26 and the rotor core 20, magnetic flux Q, which is generated when the yoke coils 35 are energized, is oriented inward in the radial direction. On the other hand, in a region in which each of the teeth 32 protrudes from the end portion 20a of the rotor core 20, the magnetic flux Q is concentrated on the outer peripheral side of the end portion 20a of the rotor core 20. As a result, a magnetic attraction force F oriented outward in the axial direction is applied to the outer peripheral side of the end portion 20a of the rotor core 20, and one of the laminated steel plates 20A that is disposed at the end portion of the rotor core 20 may become deformed in such a way that the steel plate 20A is warped outward in the axial direction. As illustrated in FIG. 6, insulators 20B are laminated between the steel plates 20A.

In the present embodiment, as described above, the adhesive members 25A are disposed on regions of the outer peripheral surface of the rotor core 20 between the end portions 21a of the permanent magnets 21 in the axial direction and the end portions of the rotor core 20 in the axial direction. The adhesive members 25A bond the outer peripheral surfaces of some of the steel plates 20A including steel plates that are located at the end portions of the rotor core 20 in the axial direction (the steel plates 20A that are located between the end portions 21a of the permanent magnets 21 in the axial direction and the end portions of the rotor core 20 in the axial direction). Thus, the steel plates 20A that are located at the end portions of the rotor core 20 can be fixed in place in the lamination direction. As a result, it is possible to suppress deformation of the steel plates 20A during a magnetizing operation.

The adhesive members 25A are formed from an adhesive that has been applied the bonding grooves 23 and has leaked out from the end portions 21a outward in the axial direction. The adhesive that has leaked out may be used as it is, or may be smoothed over a desired region of the outer peripheral surface of the rotor core 20 after having leaked out.

### Advantages of Embodiment

As heretofore described, according to the present embodiment, the rotor 3 of the rotating electric machine 1 includes the adhesive members 25A, which are disposed on regions of the outer peripheral surface of the rotor core 20 between the end portions 21a of the permanent magnets 21 in the axial direction and the end portions 20a of the rotor core 20 in the axial direction. Therefore, the outer peripheral surfaces of the end portions of the rotor core 20 in the axial direction can be bonded in the lamination direction. Thus, it is possible to suppress deformation of the steel plates 20A that are disposed at end portions of the rotor core 20 during a magnetizing operation. As a result, the reliability of the rotating electric machine 1 can be increased.

In particular, in the present embodiment, the adhesive members 25A are leaked-out portions of an adhesive, which are formed when the adhesive, for bonding the permanent magnets 21 to the rotor core 20, leaks out from the end portion 21a of the permanent magnet 21 in the axial direction. Thus, the following advantage is obtained.

It might be possible to suppress deformation of the end portions 20a of the rotor core 20 during a magnetizing operation by, for example, increasing the number of crimped portions of the rotor core 20 to increase a force for fastening the steel plates 20A. In this case, however, due to the increase of the number of crimping portions, the flow of magnetic flux in the magnetic pole portions may be impeded and the performance of the rotating electric machine 1 may be reduced. Moreover, the cost is increased because it is necessary to change a die for forming the steel plates 20A. It might be possible to suppress the deformation by additionally performing a step for bonding the steel plates 20A located at end portions in the process of manufacturing the rotor core 20. In this case, however, the number of manufacturing steps is increased and the cost is increased.

In the present embodiment, as described above, the leaked-out portions, which are formed when an adhesive for fixing the permanent magnets 21 to the outer peripheral surface of the rotor core 20 leaks out from the end portions of the permanent magnets 21 in the axial direction, are used as the adhesive members 25A. Thus, it is not necessary to increase the number of crimped portions as described above, and therefore the performance of the rotating electric machine 1 is not reduced and it is not necessary to change a die for forming the steel plates 20A. As a result, the cost can be reduced. Moreover, because it is not necessary to perform the bonding step additionally, the number of manufacturing steps and the cost are not increased.

In the present embodiment, in particular, the rotor core 20 includes the plurality of bonding grooves 23, to which the permanent magnets 21 are bonded, and the protrusions 24, which are located between the bonding grooves 23. The bonding grooves 23 and the protrusions 24 are alternately arranged on the outer peripheral surface in a rotation direction. Thus, it is possible to guide an adhesive, which has leaked out from the end portions of the permanent magnets 21 in the axial direction, so that the adhesive extends outward in the axial direction by using the protrusions 24, which are located on both sides of the adhesive in the rotation direction.

### Modification

Embodiments of the disclosure are not limited to the embodiment described above and can be modified in various ways within the spirit and scope of the disclosure.

For example, in the embodiment described above, in a cross-section view, each of the permanent magnets 21 is shaped like a substantially arc-shaped plate (or a substantially rectangular plate), and the permanent magnets 21 are disposed on the outer peripheral surface of the rotor core 20. Alternatively, as illustrated in FIG. 7, for example, an annular permanent magnet 28 may be used instead of the permanent magnets 21. The permanent magnet 28 is formed by magnetizing an annular magnet member so that different portions of the magnet member have different polarities. Other configurations, such as the length of each of the permanent magnets 28 in the axial direction being less than that of the rotor core 20, are the same as those of the embodiment described above.

Also in this case, as in the embodiment described above, an adhesive for affixing the magnetized permanent magnets 28 to the outer peripheral surface of the rotor core 20 is made to leak out from the end portions of the permanent magnets 28 in the axial direction. Therefore, the adhesive members 25A are formed from the adhesive that has leaked out to regions between the end portions of the permanent magnets 28 and the end portions of the rotor core 20 before the permanent magnets 28 are magnetized. Thus, it is possible to suppress deformation of the steel plates 20A that are disposed at the end portions of the rotor core 20, which may occur when the permanent magnets 28 are magnetized by using the magnetizing apparatus 30 including the magnetizing yoke 34 (the teeth 32) that is longer than the rotor core 20 in the axial direction.

In the above description, the adhesive members 25A are formed by making an adhesive, for bonding the permanent magnets 21 to the rotor core 20, leak out from the end portions of the permanent magnets 21 in the axial direction. However, this is not a limitation, and a step of applying an adhesive to form the adhesive members 25A may be performed independently.

In the above description, an example in which the rotating electric machine 1 has a slot combination of 10-pole/12-slot is described. However, this is not a limitation. The rotating electric machine 1 may have a different slot combination, such as 8-pole/10-slot.

In the above description, an example in which the rotating electric machine 1 is a motor is described. However, this is not a limitation. The present embodiment can be used in a case where the rotating electric machine 1 is a generator.

Other techniques used in the embodiment and modification described above may be used in combination as appropriate.

It should be understood by those skilled in the art that various modifications, combinations, sub-combinations and alterations may occur depending on design requirements and other factors insofar as they are within the scope of the appended claims or the equivalents thereof.

What is claimed is:

1. A rotor for a rotating electric machine, the rotor comprising:
a rotor core including a plurality of laminated steel plates;
a permanent magnet fixed to an outer peripheral surface of the rotor core, the permanent magnet having a length in an axial direction less than that of the rotor core; and
an adhesive member disposed on a region of the outer peripheral surface of the rotor core between an end of the permanent magnet in the axial direction and an end of the rotor core in the axial direction.

2. The rotor for a rotating electric machine according to claim 1,
wherein the permanent magnet is fixed to the outer peripheral surface of the rotor core by using an adhesive, and
wherein the adhesive member is a leaked-out portion of the adhesive that has leaked out from the end of the permanent magnet in the axial direction.

3. The rotor for a rotating electric machine according to claim 2,
wherein the rotor core includes a plurality of bonding grooves to which the permanent magnet is bonded and protrusions located between the bonding grooves, the bonding grooves and the protrusions being alternately arranged on the outer peripheral surface in a rotation direction.

4. A rotor for a rotating electric machine, the rotor comprising:
a rotor core including a plurality of laminated steel plates;
a permanent magnet fixed to an outer peripheral surface of the rotor core, the permanent magnet having a length in an axial direction less than that of the rotor core; and
means for bonding the plurality of steel plates in a lamination direction, the means being disposed on a region of the outer peripheral surface of the rotor core between an end of the permanent magnet in the axial direction and an end of the rotor core in the axial direction.

5. A rotating electric machine comprising:
a stator;
a rotor according to claim 1; and
a shaft to which the rotor is fixed.

6. A magnetizing apparatus for magnetizing the rotor for a rotating electric machine according to claim 1, the magnetizing apparatus comprising:
a magnetizing yoke having a length in the axial direction greater than that of the rotor core.
